(19) United States
(12) Patent Application Publication
(10) Pub. No.: US 2006/0118140 A1
(43) Pub. Date: Jun. 8, 2006

(54) Substrate treating method and apparatus

(75) Inventors: Takashi Nishimura, Kyoto (JP); Tsuyoshi Tomita, Kyoto (JP); Yoshihiko Sudo, Kyoto (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 11/235,002

(22) Filed: Sep. 22, 2005

(30) Foreign Application Priority Data
Sep. 30, 2004 (JP) 2004-287523

(51) Int. Cl. B08B 3/00; B08B 3/12

(52) U.S. Cl. 134/34; 134/184; 134/94.1

(57) ABSTRACT

When substrates are immersed in a treating solution stored in an inner tank, micro bubbles are formed in large quantities. Nitrogen gas nozzles supply nitrogen gas to the surface of the treating solution, while the substrates are immersed in the solution. The nitrogen gas supplied drives the bubbles on the surface from the inner tank to an outer tank, thereby removing the bubbles from the inner tank. Since the bubbles are driven to the outer tank while the substrates are immersed, particles have a reduced chance of adhering to the substrates when the latter are withdrawn up from the treating solution in the inner tank.

### BACKGROUND OF THE INVENTION

(1) Field of the Invention

This invention relates to a substrate treating method and apparatus for performing various treatments such as stripping treatment, etching treatment and cleaning treatment of semiconductor wafers, glass substrates for liquid crystal displays, glass substrates for photomasks, and substrates for optical disks (hereinafter simply called substrates). More particularly, the invention relates to a technique of treating substrates immersed in a treating solution stored in a tank.

(2) Description of the Related Art

Conventionally, the treatments noted above include stripping treatment as disclosed in Japanese Unexamined Patent Publication No. 2002-100605, for example. In this stripping treatment, substrates coated with film such as photoresist film are immersed in an organic or aminic treating solution to remove the coating film.

In the conventional stripping treatment, when substrates or wafers W are immersed in a treating solution heated to 70° C., as shown in FIG. 1, minute bubbles (micro bubbles) Mb develop in large quantities in the treating solution. These bubbles Mb float upward and linger on the surface of the treating solution. With the bubbles Mb, particles also linger on the surface of the treating solution. The presence of the bubbles Mb causes the problem of the particles adhering to the wafers W when the wafers W are withdrawn upward from the treating solution.

### SUMMARY OF THE INVENTION

This invention has been made having regard to the state of the art noted above, and its object is to provide a substrate treating method and apparatus for eliminating bubbles from the surface of a treating solution to diminish the chance of particles adhering to substrates.

The above object is fulfilled, according to this invention, by a substrate treating method for treating substrates with a treating solution, comprising a step of supplying a fluid to a surface of the treating solution in a tank from one side of the tank, while the substrates are immersed in the treating solution, to drive bubbles present on the surface of the treating solution to a side opposed to the one side and outwardly of the tank.

With the substrate treatment method according to this invention, a fluid is supplied to the surface of the treating solution in the tank from one side of the tank, while the substrates are immersed in the treating solution. As a result, the bubbles present on the surface of the treating solution are driven to the side opposed to the one side and outwardly of the tank. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

Another substrate treating method for treating substrates with a treating solution, according to this invention, comprises a step of supplying a fluid to a central region on a surface of the treating solution stored in a tank, while the substrates are immersed in the treating solution, to drive bubbles from the central region on the surface of the treating solution outwardly toward peripheries of the tank.

With the above substrate treatment method according to this invention, a fluid is supplied to the central region on the surface of the treating solution in the tank, while the substrates are immersed in the treating solution. As a result, the bubbles are driven from the central region on the surface of the treating solution outwardly toward peripheries of the tank, and out of the tank. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

In the above substrate treating methods, the fluid may be an inert gas. An inert gas can drive the bubbles outwardly of the tank without causing a chemical reaction with the treating solution.

A further substrate treating method for treating substrates with a treating solution, according to this invention, comprises a step of supplying a fluid to a surface of the treating solution stored in a tank, while the substrates are immersed in the treating solution, to destroy bubbles present on the surface of the treating solution with the fluid.

With the further substrate treatment method according to this invention, a fluid is supplied to the surface of the treating solution in the tank, while the substrates are immersed in the treating solution, the fluid striking and destroying the bubbles present on the surface of the treating solution. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

In the further substrate treating method noted above, the fluid may be the same treating solution as the treating solution stored in the tank. The treating solution supplied to the surface of the treating solution may comprise part of the treating solution once discharged from the tank. Preferably, the fluid is an inert gas hotter than the treating solution. An inert gas hotter than the treating solution, because of its heat, can destroy the bubbles with ease.

In another aspect of the invention, a substrate treating apparatus for treating substrates with a treating solution, comprises a tank for storing the treating solution, and a fluid supply mechanism for supplying a fluid to a surface of the treating solution in the tank from one side of the tank, while the substrates are immersed in the treating solution, to drive bubbles present on the surface of the treating solution to a side opposed to the one side and outwardly of the tank.

With the substrate treatment apparatus according to this invention, the fluid supply mechanism supplies a fluid to the surface of the treating solution in the tank from one side of the tank, while the substrates are immersed in the treating solution. As a result, the bubbles present on the surface of the treating solution are driven to the side opposed to the one side and outwardly of the tank. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

The above substrate treating apparatus may further comprise an open/close lid having two lid members for opening and closing an upper opening of the tank, the fluid supply mechanism being disposed on one of the two lid members. With the fluid supply mechanism disposed on one of the lid members, there is no need to secure a separate space for accommodating the fluid supply mechanism. When the lid members are opened, the fluid supply mechanism presents no obstruction to loading and unloading of the substrates into/out of the tank.

Another substrate treating apparatus for treating substrates with a treating solution, according to this invention, comprises a tank for storing the treating solution, and a fluid supply mechanism for supplying a fluid to a central region on a surface of the treating solution in the tank, while the substrates are immersed in the treating solution, to drive bubbles from the central region on the surface of the treating solution outwardly toward peripheries of the tank.

With the above substrate treatment apparatus according to this invention, the fluid supply mechanism supplies a fluid to the central region on the surface of the treating solution in the tank, while the substrates are immersed in the treating solution. As a result, the bubbles are driven from the central region on the surface of the treating solution outwardly toward peripheries of the tank, and out of the tank. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

The above substrate treating apparatus may further comprise an open/close lid having two lid members for opening and closing an upper opening of the tank, the fluid supply mechanism being disposed on each of the two lid members. With the fluid supply mechanism disposed on each lid member, there is no need to secure a separate space for accommodating the fluid supply mechanism. When the lid members are opened, the fluid supply mechanism presents no obstruction to loading and unloading of the substrates into/out of the tank.

In the above substrate treating apparatus, the fluid may be an inert gas. An inert gas can drive the bubbles outwardly of the tank without causing a chemical reaction with the treating solution.

A further substrate treating apparatus for treating substrates with a treating solution, according to this invention, comprises a tank for storing the treating solution, and a fluid supply mechanism for supplying a fluid from at least two opposite directions to a surface of the treating solution stored in the tank, while the substrates are immersed in the treating solution, to destroy bubbles present on the surface of the treating solution with the fluid.

With the further substrate treatment apparatus according to this invention, the fluid supply mechanism supplies a fluid from at least two opposite directions to the surface of the treating solution stored in the tank, while the substrates are immersed in the treating solution. As a result, the fluid strikes and destroys the bubbles present on the surface of the treating solution. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank.

A still further substrate treating apparatus for treating substrates with a treating solution, according to this invention, comprises an inner tank for storing the treating solution, an outer tank for collecting the treating solution overflowing an upper opening of the inner tank, piping having one end thereof connected to the outer tank for discharging the treating solution from the outer tank, and a fluid supply mechanism connected to the other end of the piping for supplying the treating solution discharged from the outer tank, from at least two opposite directions to a surface of the treating solution stored in the inner tank, while the substrates are immersed in the treating solution, to destroy bubbles present on the surface of the treating solution with the treating solution supplied.

With the still further substrate treatment apparatus according to this invention, the fluid supply mechanism supplies a fluid from at least two opposite directions to the surface of the treating solution stored in the tank. As a result, the fluid strikes and destroys the bubbles present on the surface of the treating solution. Thus, the bubbles, which would cause particle adhesion to the substrates, are removed from the surface of the treating solution. This reduces the chance of particles adhering to the substrates due to the bubbles when the substrates are withdrawn up from the treating solution stored in the tank. In addition, efficiency is achieved since the treating solution discharged from the outer tank is reused.

The substrate treating apparatus noted above may further comprise an open/close lid having two lid members for opening and closing an upper opening of the tank, the fluid supply mechanism being disposed on each of the two lid members. With the fluid supply mechanism disposed on each lid member, there is no need to secure a separate space for accommodating the fluid supply mechanism. When the lid members are opened, the fluid supply mechanism presents no obstruction to loading and unloading of the substrates into/out of the tank.

In the substrate treating apparatus noted above, the fluid supply mechanism may have an adjustable fluid delivery angle. With an adjustable fluid delivery angle, the fluid (treating solution) may be directed reliably to regions on the surface of the treating solution where bubbles are present in large quantities.

A different substrate treating apparatus for treating substrates with a treating solution, according to this invention, comprises an inner tank for storing the treating solution, an open/close lid having two lid members for opening and closing an upper opening of the tank, and a fluid supply mechanism for supplying the treating solution to a surface of the treating solution stored in the inner tank, while the substrates are immersed in the treating solution, to destroy bubbles present on the surface of the treating solution with the treating solution supplied, the fluid supply mechanism including plate-like nozzles formed on the two lid members, respectively, and each having a plurality of discharge openings.

With the different substrate treatment apparatus according to this invention, the fluid supply mechanism supplies the treating solution from a plurality of discharge openings to destroy the bubbles present on the surface of the treating solution. Since the bubbles present on the surface of the treating solution are struck and destroyed by the treating solution supplied, the bubbles, which would cause particle adhesion to the substrates, are removed from the surface of the treating solution. This reduces the chance of particles adhering to the substrates due to the bubbles when the substrates are withdrawn up from the treating solution stored in the tank.

The different substrate treating apparatus noted above may further comprise an outer tank for collecting the treating solution overflowing the upper opening of the inner tank, and piping having one end thereof connected to the outer tank for discharging the treating solution from the outer tank, the plate-like nozzles being connected to the other end of the piping for supplying the treating solution from the discharge openings to an entire surface of the treating solution stored in the inner tank. This construction achieves efficiency since the treating solution discharged from the outer tank is reused.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 (PRIOR ART) is an explanatory view schematically showing a situation where minute bubbles (micro bubbles) have developed in large quantities;

FIG. 2 is a block diagram showing an outline of a substrate treating apparatus in a first embodiment;

FIG. 3 is a sectional view of a lid of a treating tank of the substrate treating apparatus, and an explanatory view schematically showing how bubbles are driven from an inner tank to an outer tank;

FIG. 4 is a schematic view of a transport mechanism;

FIG. 5 is a flow chart of treating operation of the substrate treating apparatus in the first embodiment;

FIG. 6 is a sectional view of a substrate treating apparatus in a second embodiment, and an explanatory view schematically showing how bubbles are driven from an inner tank to an outer tank;

FIG. 7 is a sectional side view of a nitrogen gas supply pipe formed in a lid;

FIG. 8 is a block diagram showing an outline of a substrate treating apparatus in a third embodiment;

FIG. 9 is a plan view of treating solution supply pipes formed in a lid;

FIG. 10A is an explanatory view schematically showing how bubbles are destroyed by a treating solution;

FIG. 10B is an explanatory view schematically showing how bubbles are destroyed by the treating solution;

FIG. 11 is a flow chart of treatment operation of the substrate treating apparatus in the third embodiment;

FIG. 12 is a sectional view of a substrate treating apparatus in a fourth embodiment;

FIG. 13 is a plan view of treating solution supply pipes formed in a lid;

FIG. 14 is a sectional view of a substrate treating apparatus in a fifth embodiment;

FIG. 15 is a plan view of treating solution supply pipes formed in a lid;

FIG. 16A is a sectional view of a substrate treating apparatus combining different embodiments;

FIG. 16B is a sectional view of a substrate treating apparatus combining different embodiments;

FIG. 16C is a sectional view of a substrate treating apparatus combining different embodiments; and

FIG. 16D is a sectional view of a substrate treating apparatus combining different embodiments.

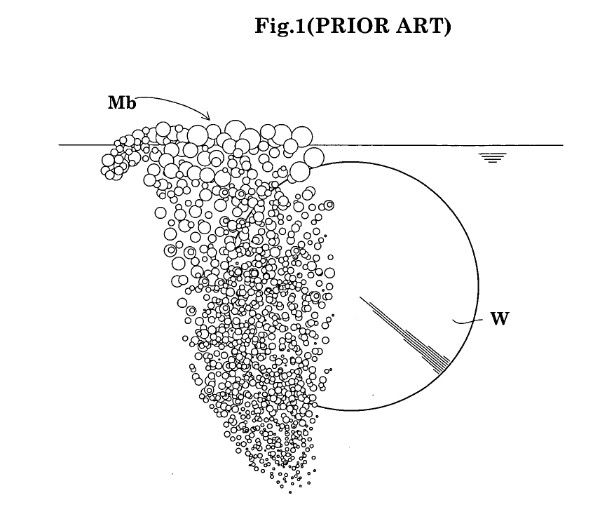

### DESCRIPTION OF THE PREFERRED EMBODIMENTS

Preferred embodiments of this invention will be described in detail hereafter with reference to the drawings.

### First Embodiment

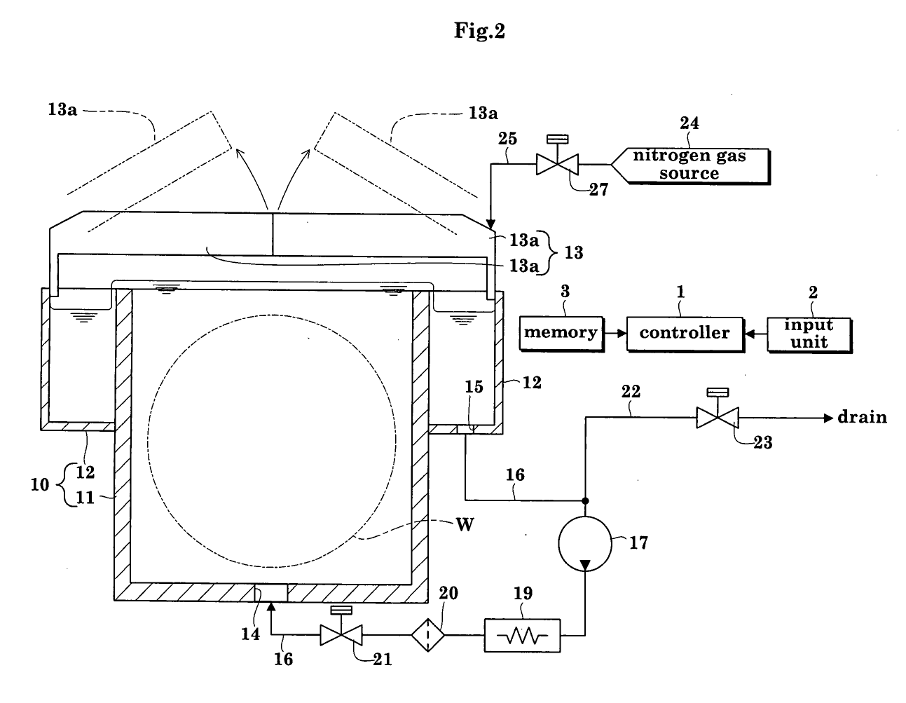

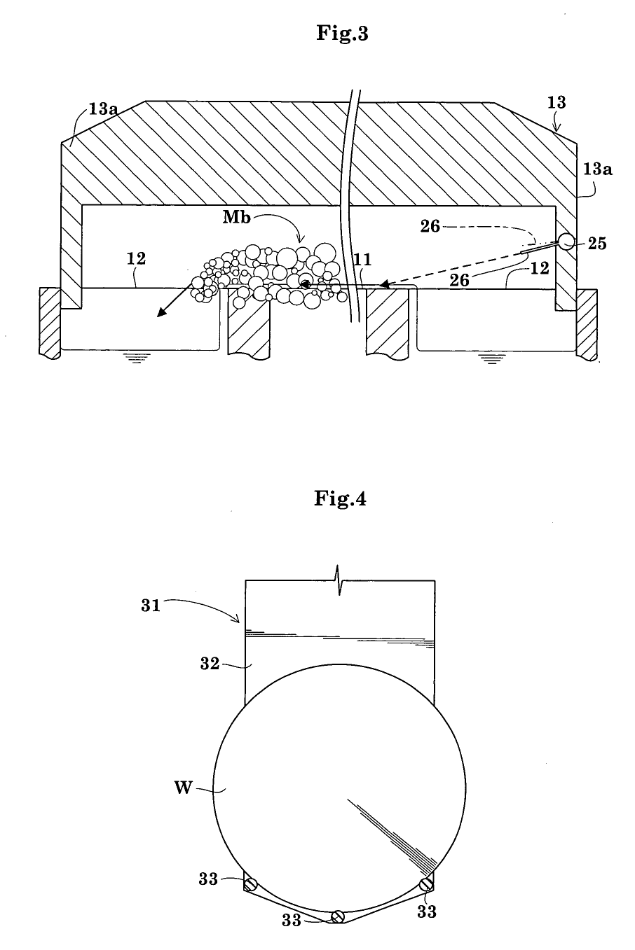

FIG. 2 is a block diagram showing an outline of a substrate treating apparatus in a first embodiment. FIG. 3 is a sectional view of a lid of a treating tank of the substrate treating apparatus, and an explanatory view schematically showing how bubbles are driven from an inner tank to an outer tank. FIG. 4 is a schematic view of a transport mechanism.

The substrate treating apparatus in the first embodiment, including those in the second to fifth embodiments described hereinafter, is constructed for performing stripping treatment to immerse substrates coated with film such as photoresist film in an organic or aminic treating solution to remove the coating film.

This substrate treating apparatus includes a treating tank 10. This treating tank 10 has an inner tank 11 for storing the treating solution and receiving substrates or wafers W to be immersed in the treating solution, and an outer tank 12 disposed outside the inner tank 11 for collecting the treating solution overflowing the inner tank 11. An open/close lid 13 is mounted on the treating tank 10 for sealing off the treating tank 10 from ambient air and preventing particles mixing in from the ambient. The open/close lid 13 covers the entire upper area of the treating tank 10 including the inner tank 11 and outer tank 12. The open/close lid 13 has two lid members 13a each attached to the outer tank 12 to be openable and closable. That is, the lid members 13a are movable as shown in two-dot chain lines in FIG. 2, to open the upper area of the treating tank 10. In the position shown in solid lines in FIG. 2, the lid members 13a close the upper area of the treating tank 10. When loading and unloading the wafers W into/from the inner tank 11, the lid members 13a are moved as shown in two-dot chain lines in FIG. 2, to facilitate the loading and unloading operation.

The wafers W in this example are 200 mm in diameter. In order to facilitate movement of bubbles Mb from the inner tank 11 to the outer tank 12, it is desirable to set a long distance between the surface of the treating solution in the inner tank 11 and the open/close lid 13, and a large gap between the outer tank 12 and the open/close lid 13. When performing stripping treatment of the wafers W 200 mm in diameter with an organic or aminic treating solution, it is desirable to set the distance between the surface of the treating solution and the open/close lid 13 to about 20 mm, and the gap between the outer tank 12 and the open/close lid 13 to about 13 mm.

The inner tank 11 has a feed port 14 formed in the bottom thereof for introducing the treating solution into the inner tank 11. The outer tank 12 has a drain port 15 formed in the bottom thereof for draining the treating solution out of the outer tank 12. The feed port 14 and drain port 15 are in communication through circulation piping 16. The circulation piping 16 has a pump 17, an in-line heater 19, a filter 20 and a switch valve 21 arranged in order from upstream to downstream. A branch pipe 22 is connected to the circulation piping 16 between the drain port 15 and pump 17. The branch pipe 22 has a switch valve 23 mounted thereon, which is operable to drain the treating solution from the outer tank 12 through the drain port 15, circulation piping 16 and branch pipe 22.

The in-line heater 19 has a heating element coated with fluororesin which is highly resistant to chemicals, and is thus resistant to the treating solution. The in-line heater 19 heats the treating solution flowing through the circulation piping 16 to a predetermined temperature (i.e. about 70° C. in the first to fifth embodiments).

The open/close lid 13 has a nitrogen gas supply pipe 25 formed in a side wall thereof adjacent the outer tank 12 as shown in FIG. 3, which supply pipe 25 extends from a nitrogen gas source 24. The nitrogen gas supply pipe 25 is connected to nitrogen gas nozzles 26. The nitrogen gas supply pipe 25 has a switch valve 27 (FIG. 2) operable to supply nitrogen gas from the nitrogen gas source 24 to the nitrogen gas nozzles 26 through the nitrogen gas supply pipe 25. The nitrogen gas nozzles 26 are attached to one of the lid members 13a in positions obliquely upward of the inner tank 11, and have discharge openings directed toward the center of the inner tank 11. A mechanism (not shown) is provided for adjusting the angle of the discharge openings of the nitrogen gas nozzles 26.

The apparatus includes a transport mechanism 31 which, as shown in FIG. 4, is constructed to move the wafers W vertically relative to the inner tank 11 (FIG. 2). The transport mechanism 31 includes a back plate 32 having longer sides extending vertically, and three support elements 33 extending horizontally from a lower end of the back plate 32. Each support element 33 has a plurality of grooves formed in an upper surface thereof for contacting and supporting peripheries of the wafers W.

A controller 1 performs an overall control of the apparatus including the lid members 13a, pump 17, in-line heater 19, switch valves 21, 23 and 27, and the mechanism for adjusting the angle of the discharge openings of the nitrogen gas nozzles 26. The controller 1 outputs various commands based on input data received from an input unit 2 and programs stored in a memory unit 3, for controlling substrate treatment. The controller 1 is formed of a central processing unit (CPU) and so on. The input unit 2 includes a pointing device, typically a mouse, keyboard, joystick, trackball and/or touch panel. The memory unit 3 includes storage media, typically a ROM (Read Only Memory), a RAM (Random Access Memory) and so on.

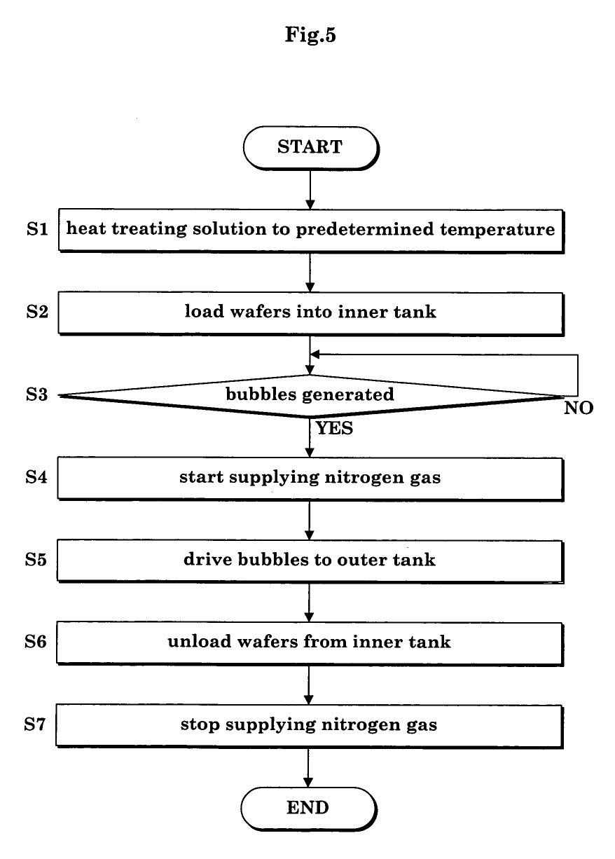

Next, a substrate treating method in the first embodiment will be described with reference to FIG. 5. FIG. 5 is a flow chart showing treating operation of the substrate treating apparatus in the first embodiment.

(Step S1) Heat Treating Solution to Predetermined Temperature

When supplying a fresh treating solution to the treating tank 10, a treating solution feed mechanism (not shown) is operated to supply the fresh treating solution to the inner tank 11, and the controller 1 is operated to open the switch valve 23. As a result, the treating solution is drained from the drain port 15 of the outer tank 12 through the circulation piping 16 and branch pipe 22, and the fresh treating solution is supplied to the inner tank 11. When circulating the treating solution drained from the drain port 15 of the outer tank 12 through the circulation piping 16 to the inner tank 11, the controller 1 is operated to close the switch valve 23, actuate the pump 17, and open the switch valve 21. As a result, the treating solution drained from the drain port 15 of the outer tank 12 is supplied into the inner tank 11 through the circulation piping 16 and feed port 14. Further, the controller 1 is operated to control the in-line heater 19 and heat the treating solution to the predetermined temperature. In this step, and in the steps described hereinafter, the controller 1 outputs various commands to the pump 17, the various switch valves and so on, based on input data received from the input unit 2 and the programs stored in the memory unit 3.

(Step S2) Load Wafers into Inner Tank

The transport mechanism 31 holding a plurality of wafers W is lowered to the inner tank. As a result, the wafers W are immersed in the treating solution stored in the inner tank 11.

(Step S3) Bubbles Generate

When the wafers W are immersed in the treating solution in the inner tank 11, as shown in FIG. 3, a reaction occurs between the treating solution and coating film on the surfaces of the wafers W, to generate minute bubbles (micro bubbles) Mb in large quantities in the treating solution. The operation repeats step S3 and stands by until such bubbles Mb are generated.

(Step S4) Start Supplying Nitrogen Gas

The bubbles Mb generated ascend in the treating solution, and linger on the surface of the treating solution as shown in FIG. 3. The controller 1 is operated to open the switch valve 27. As a result, nitrogen gas flows from the nitrogen gas source 24 through the nitrogen gas supply pipe 25 to the nitrogen gas nozzles 26. The nitrogen gas nozzles 26 supply the nitrogen gas to the surface of the treating solution from the positions obliquely upward of the inner tank 11. The angle of the discharge openings of the nitrogen gas nozzles 26 may be adjusted, as necessary, by moving the discharge openings as shown in a two-point chain line in FIG. 3. With such movement, the nitrogen gas may be supplied from the nitrogen gas nozzles 26 to varied locations as necessary. The angle of the discharge openings is not limited to what is shown in the two-point chain line in FIG. 3, but may be adjusted in depth directions perpendicular to the plane of FIG. 3.

(Step S5) Drive Bubbles to Outer Tank

When the nitrogen gas nozzles 26 supply nitrogen gas to the surface of the treating solution as indicated by arrows in FIG. 3, the nitrogen gas flows along the surface of the treating solution, past the center of the inner tank 11, to the side of the outer tank 12 remote from the nitrogen gas nozzles 26. The bubbles Mb present on the surface of the treating solution are driven by the nitrogen gas from the inner tank 11 to the outer tank 12. In this way, the bubbles Mb are removed from the inner tank 11.

(Step S6) Unload Wafers from Inner Tank

The wafers W are immersed in the treating solution in the inner tank 11 for a predetermined time. Upon completion of the treatment for stripping off the coating film, the transport mechanism 31 holding the wafers W is raised from the inner tank 11. The supply of nitrogen gas is continued also in time of withdrawing the wafers W from the inner tank 11 since the bubbles Mb could remain on the surface of the treating solution without being removed from the inner tank 11. It is desirable to adjust the angle of the discharge openings of the nitrogen gas nozzles 26 to supply the nitrogen gas toward the wafers W, thereby to drive particularly those bubbles Mb present adjacent the wafers W to the outer tank 11.

(Step S7) Stop Supplying Nitrogen Gas

When the transport mechanism 31 has raised the wafers W out of the treating solution to unload them from the inner tank 11, the controller 1 is operated to close the switch valve 27. This operation stops the supply of nitrogen gas from the nitrogen gas nozzles 26. The supply of nitrogen gas may be continued for treating subsequent lots of wafers W.

According to the substrate treating apparatus in the first embodiment, the nitrogen gas nozzles 26 supply nitrogen gas to the surface of the treating solution while the wafers W are immersed in the treating solution in the inner tank 11, to drive the bubbles Mb present on the surface from the inner tank 11 to the outer tank 12. With the nitrogen gas driving the bubbles Mb outwardly of the inner tank 11 as above, the bubbles Mb may be removed from the inner tank 11. Since bubbles Mb on the surface of the treating solution are driven to the outer tank 12 while the wafers W are immersed in the treating solution, particles have a reduced chance of adhering to the wafers W being withdrawn up from the treating solution in the inner tank 11.

Further, a gas such as nitrogen gas that flows along the surface of the treating solution can easily drive the bubbles Mb from the inner tank 11 to the outer tank 12. Being an inert gas, nitrogen gas can drive the bubbles Mb to the outer tank 12 with no chemical reaction with the treating solution.

In the first embodiment, the nitrogen gas nozzles 26 have the angle adjusting mechanism operable by the controller 1, to vary positions to which nitrogen gas is supplied from the nozzles 26. With this mechanism, nitrogen gas may be supplied to varied positions according to the state of bubbles Mb, thereby to remove the bubbles Mb efficiently.

### Second Embodiment

Next, a second embodiment of this invention will be described with reference to the drawings.

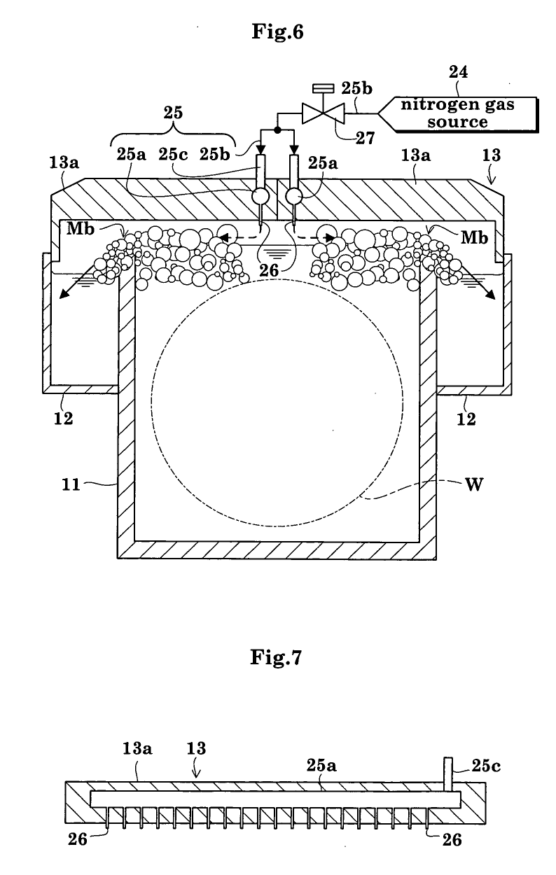

FIG. 6 is a sectional view of a substrate treating apparatus in the second embodiment, and an explanatory view schematically showing how bubbles are driven from an inner tank to an outer tank. FIG. 7 is a sectional side view of a nitrogen gas supply pipe formed in a lid.

Like reference numerals are used to identify like parts which are the same as in the first embodiment and will not be described again. Only different parts will be described hereinafter. The various components provided for the inner tank 11, outer tank 12, transport mechanism 31 and circulation piping 16 are the same as in the first embodiment. In the second embodiment, the supply system for supplying nitrogen gas is different from what is shown in the first embodiment.

In this embodiment, the nitrogen gas supply pipe 25 includes portions 25a formed in the lid member 13a, and a portion 25b adjacent the switch valve 27. As shown in FIG. 6, the supply pipes 25a and supply pipe 25b are connected through flexible tubes 25c. Downstream of the switch valve 27, the supply pipe 25b is divided into two branches each connected through one of the flexible tubes 25c to one of the supply pipes 25a. In the second embodiment, as shown in FIG. 6, the two supply pipes 25a are formed adjacent the center of the two lid members 13a.

Nitrogen gas nozzles 26 are connected to these two supply pipes 25a. The nitrogen gas nozzles 26 are arranged in the respective lid members 13a to project toward a central region on the surface of the treating solution stored in the inner tank 11. Each nitrogen gas nozzle 26 has a discharge opening directed to the surface of the treating solution. As in the first embodiment, a mechanism is provided for adjusting the angle of the discharge openings of the nitrogen gas nozzles 26.

As indicated by arrows in FIG. 6, when each nitrogen gas nozzle 26 supplies nitrogen gas to the surface of the treating solution, the nitrogen gas flows along the surface of the treating solution from the center of the inner tank 11 toward each outer tank 12. That is, the nitrogen gas delivered from the nitrogen gas nozzles 26 arranged at the left-hand side of the center in FIG. 6 flows toward the left outer tank 12, and the nitrogen gas delivered from the nitrogen gas nozzles 26 arranged at the right-hand side of the center flows toward the right-hand outer tank 12. The bubbles Mb present on the surface of the treating solution are driven by the nitrogen gas flows from the inner tank 11 to the outer tanks 12. Thus, the bubbles Mb are removed from the inner tank 11.

The functions and effects of the substrate treating method and substrate treating apparatus in the second embodiment are the same as in the first embodiment, the only difference being the flows of nitrogen gas and bubbles Mb.

### Third Embodiment

Next, a third embodiment of this invention will be described with reference to the drawings.

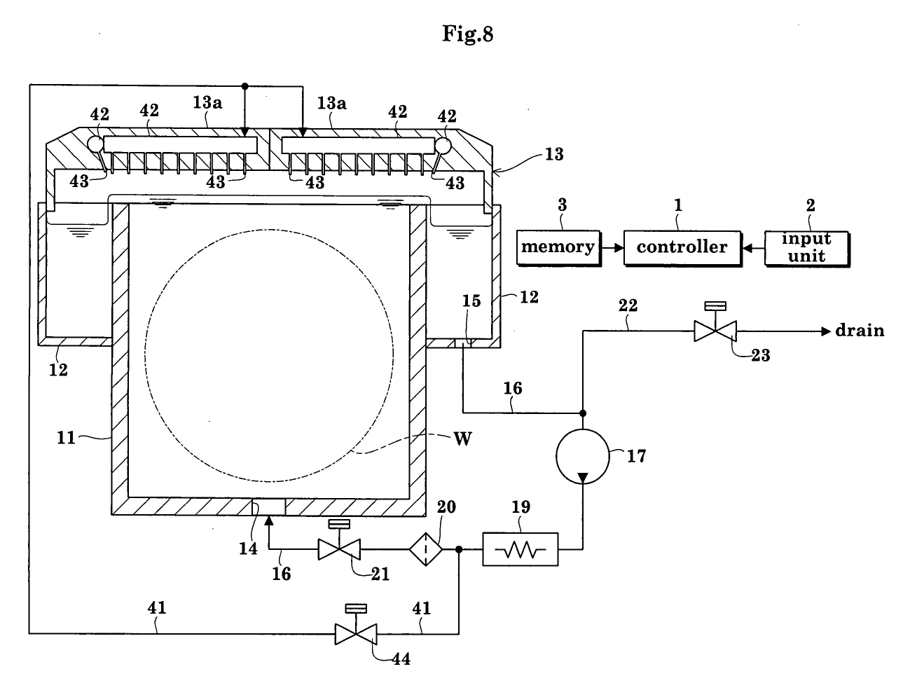

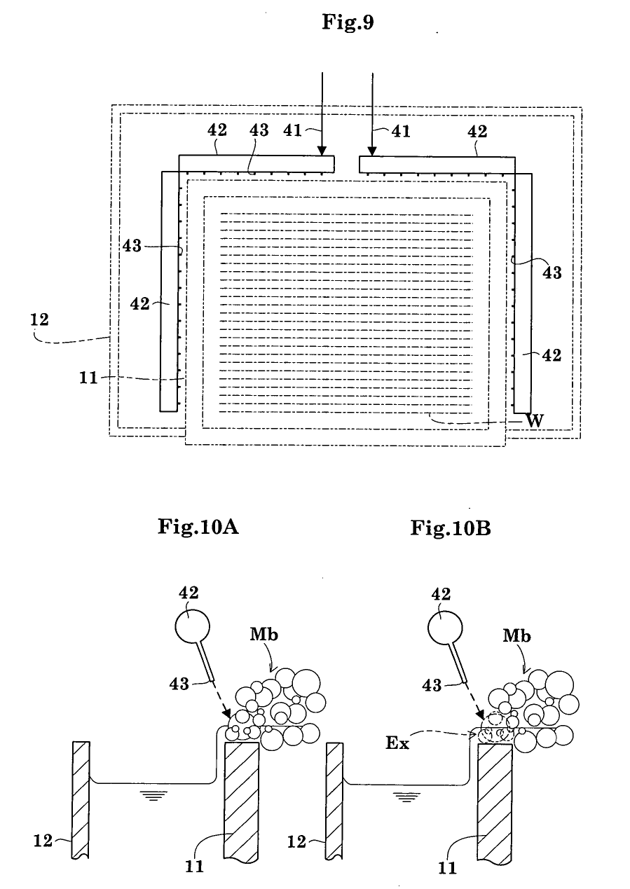

FIG. 8 is a block diagram showing an outline of a substrate treating apparatus in the third embodiment. FIG. 9 is a plan view of treating solution supply pipes formed in a lid.

Like reference numerals are used to identify like parts which are the same as in the first and second embodiments and will not be described again. Only different parts will be described hereinafter. The inner tank 11, outer tank 12 and transport mechanism 31 are the same as in the first embodiment. The third embodiment differs from the first and second embodiments in that a supply system is used here for supplying the treating solution in circulation to the surface of the treating solution, instead of the supply system for supplying nitrogen gas.

In the third embodiment, as shown in FIG. 8, a branch pipe 41 is connected to the circulation piping 16 between the in-line heater 19 and filter 20. Treating solution supply pipes 42 are connected to the branch pipe 41. As shown in FIGS. 8 and 9, the treating solution supply pipes 42 are formed in the lid members 13a so as to surround the area above the outer tank 12. In this case, as shown in FIG. 9, the outer tank 12 is disposed along three sides of the inner tank 11, and therefore the treating solution supply pipes 42 are formed in the lid members 13a to extend along the three sides.

The treating solution supply pipes 42 define a plurality of treating solution nozzles 43. The treating solution nozzles 43 have discharge openings directed toward the surface of the treating solution stored in the inner tank 11. As in the first and second embodiments, a mechanism is provided for adjusting the angle of the discharge openings of the treating solution nozzles 43.

The branch pipe 41 has a switch valve 44 mounted in an intermediate position thereof. The switch valve 44 is operable to supply part of the treating solution flowing through the circulation piping 16 to the treating solution nozzles 43 through the branch pipe 41 and treating solution supply pipes 42. The treating solution nozzles 43 supply the treating solution to three edges of the surface of the treating solution.

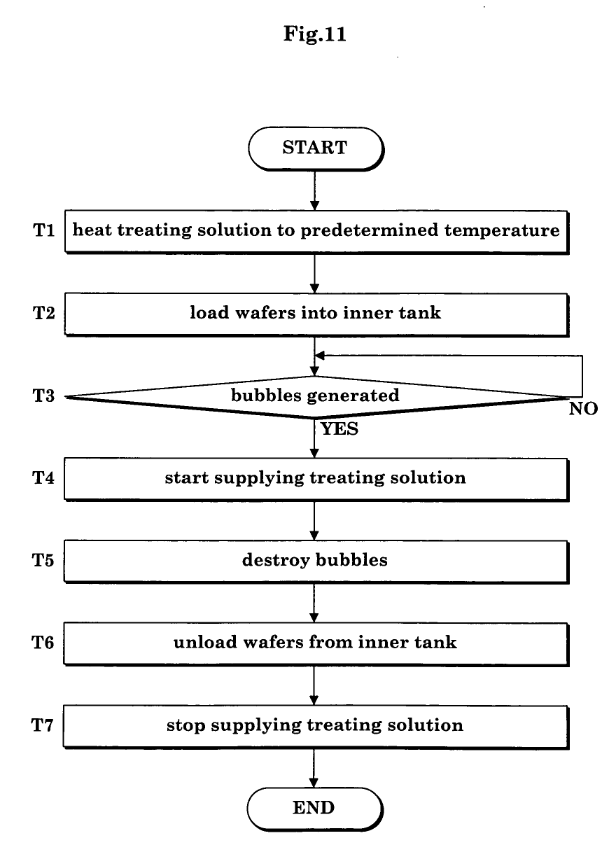

Next, a substrate treating method in the third embodiment will be described with reference to FIGS. 10A, 10B and 11. FIGS. 10A and 10B are explanatory views schematically showing how bubbles are destroyed or eliminated by the treating solution. FIG. 11 is a flow chart showing treating operation of the substrate treating apparatus in the third embodiment.

(Step T1) Heat Treating Solution to Predetermined Temperature

The controller 1 is operated to open the switch valve 21 and close the switch valve 44. As a result, the treating solution flowing through the circulation piping 16 is supplied to the inner tank 11 through the feed port 14, without permitting the treating solution to flow into the branch pipe 41. Further, the controller 1 is operated to control the in-line heater 19 and heat the treating solution to the predetermined temperature.

(Step T2) Load Wafers into Inner Tank

The transport mechanism 31 holding a plurality of wafers W is lowered to the inner tank. As a result, the wafers W are immersed in the treating solution stored in the inner tank 11.

(Step T3) Bubbles Generate

When the wafers W are immersed in the treating solution in the inner tank 11, as shown in FIGS. 10A and 10B, a reaction occurs between the treating solution and the coating film on the surfaces of the wafers W, to generate minute bubbles (micro bubbles) Mb in large quantities in the treating solution. The operation repeats step T3 and stands by until such bubbles Mb are generated.

(Step T4) Start Supplying Treating Solution

The bubbles Mb generated ascend in the treating solution, and linger on the surface of the treating solution as shown in FIGS. 10A and 10B. The controller 1 is operated to open the switch valve 44 also. As a result, part of the treating solution flowing through the circulation piping 16 is supplied to the treating solution nozzles 43 through the branch pipe 41 and treating solution pipes 42. The treating solution nozzles 43 supply the treating solution to the edges of the surface of the treating solution. The angle of the discharge openings of the treating solution nozzles 43 may be adjusted, as necessary, by moving the discharge openings. With such movement, the treating solution may be supplied from the treating solution nozzle 43 to a varied location as necessary.

(Step T5) Destroy Bubbles

The bubbles Mb on the surface of the treating solution tend to stagnate at the edges of the inner tank 11 rather than flowing smoothly into the outer tank 12. When the treating solution is supplied to the edges of the surface of the treating solution, as indicated by arrows in FIGS. 10A and 10B, part of the bubbles Mb struck by the supply as in FIG. 10A are destroyed as shown in two-point chain lines in FIG. 10B. The extinct bubbles are referenced Ex in FIG. 10B. By this destructive action, bubbles Mb are removed from the inner tank 11.

(Step T6) Unload Wafers from Inner Tank

The wafers W are immersed in the treating solution in the inner tank 11 for a predetermined time. Upon completion of the treatment for stripping off the coating film, the transport mechanism 31 holding the wafers W is raised from the inner tank 11. The supply of the treating solution is continued also in time of withdrawing the wafers W from the inner tank 11 since the bubbles Mb could remain on the surface, particularly the edges, of the treating solution without being removed from the inner tank 11. It is desirable to adjust the angle of the discharge openings of the treating solution nozzles 43, only in step T6, to supply the treating solution toward the wafers W being withdrawn, thereby to eliminate the bubbles Mb from adjacent the wafers W. Of course, the discharge openings may be maintained in the direction toward the edges to destroy the bubbles Mb stagnating at the edges.

(Step T7) Stop Supplying Treating Solution

When the transport mechanism 31 has raised the wafers W out of the treating solution to unload them from the inner tank 11, the controller 1 is operated to close the switch valve 44.

According to the substrate treating apparatus in the third embodiment, the treating solution nozzles 43 supply the treating solution to the surface of the treating solution while the wafers W are immersed in the treating solution in the inner tank 11, to destroy the bubbles Mb on the surface by means of the treating solution supplied. With the treating solution destroying the bubbles Mb, the bubbles Mb may be removed from the inner tank 11. Since bubbles Mb are destroyed while the wafers W are immersed in the treating solution, particles have a reduced chance of adhering to the wafers W being withdrawn up from the treating solution in the inner tank 11.

Since the treating solution used to destroy bubbles Mb is the same treating solution that treats the wafers W, the bubbles Mb may be destroyed while performing the treatment smoothly, with no chemical reaction occurring to the treating solution.

In the third embodiment, the treating solution nozzles 43 have the angle adjusting mechanism operable by the controller 1, to vary positions to which the treating solution is supplied from the nozzles 43. With this mechanism, the treating solution may be supplied to varied positions according to the state of bubbles Mb, thereby to remove the bubbles Mb efficiently.

### Fourth Embodiment

Next, a fourth embodiment of this invention will be described with reference to the drawings.

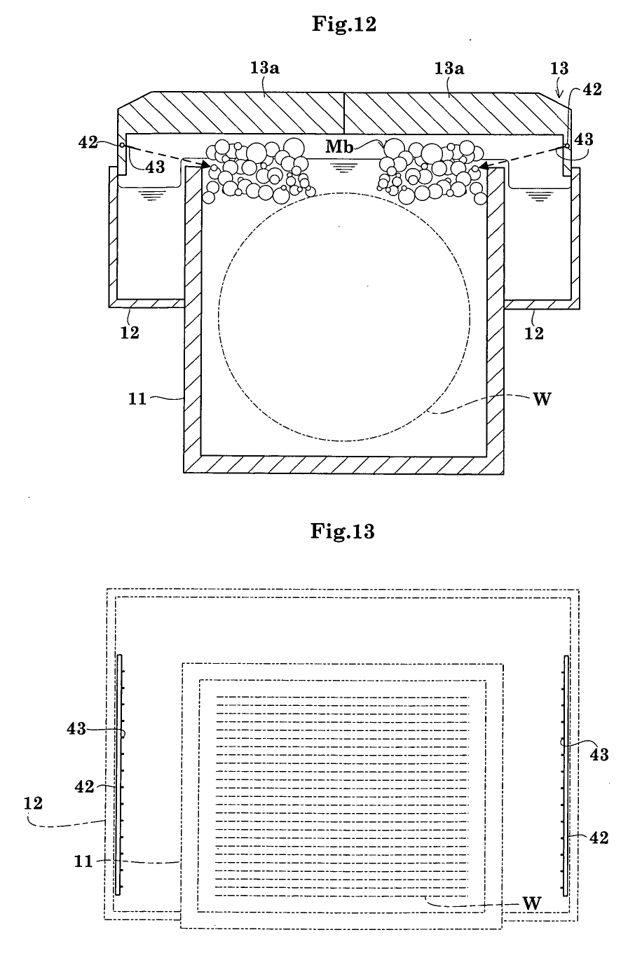

FIG. 12 is a sectional view of a substrate treating apparatus in the fourth embodiment. FIG. 13 is a plan view of treating solution supply pipes formed in a lid.

Like reference numerals are used to identify like parts which are the same as in the first to third embodiments and will not be described again. Only different parts will be described hereinafter. The various components provided for the inner tank 11, outer tank 12, transport mechanism 31 and circulation piping 16 are the same as in the third embodiment. The fourth embodiment differs from the third embodiment in the form of the supply system for supplying the treating solution in circulation.

In the fourth embodiment, as shown in FIG. 12, treating solution supply pipes 42 are formed in the side walls of the respective lid members 13a adjacent the outer tank 12 to extend parallel and opposed to each other. Each treating solution supply pipe 42 defines a plurality of treating solution nozzles 43. The discharge openings of the treating solution nozzles 43 are directed to the surface of the treating solution. As in the first to third embodiments, a mechanism is provided for adjusting the angle of the discharge openings of the treating solution nozzles 43. The discharge openings may be directed to the edges of the inner tank 11 or to where bubbles Mb are present.

When the treating solution nozzles 43 supply the treating solution to the surface of the treating solution, as indicated by arrows in FIG. 12, part of the bubbles Mb struck by the supply are destroyed. By this destructive action, the bubbles Mb are removed from the inner tank 11.

The functions and effects of the substrate treating method and substrate treating apparatus in the fourth embodiment are the same as in the third embodiment, the only difference being the flows of the treating solution and bubbles Mb.

### Fifth Embodiment

Next, a fifth embodiment of this invention will be described with reference to the drawings.

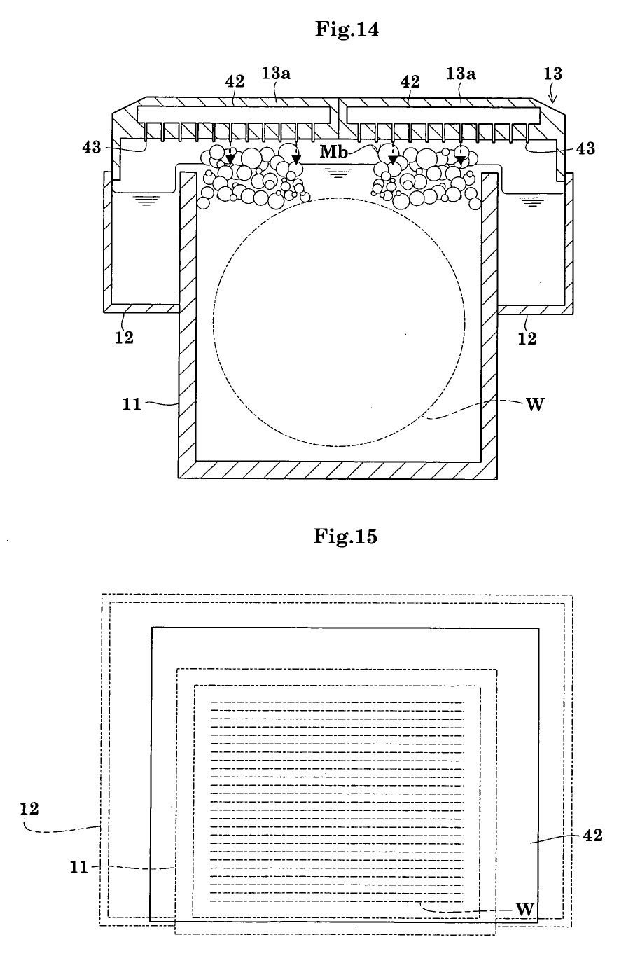

FIG. 14 is a sectional view of a substrate treating apparatus in the fifth embodiment. FIG. 15 is a plan view of treating solution supply pipes formed in a lid.

Like reference numerals are used to identify like parts which are the same as in the first to fourth embodiments and will not be described again. Only different parts will be described hereinafter. The various components provided for the inner tank 11, outer tank 12, transport mechanism 31 and circulation piping 16 are the same as in the third and fourth embodiments. The fifth embodiment differs from the third and fourth embodiments in the form of the supply system for supplying the treating solution.

In the fifth embodiment, each lid member 13a shown in FIG. 14 has a treating solution supply pipe 42 in the form of a plate as shown in FIG. 15. As shown in FIG. 14, each treating solution supply pipe 42 is in communication with treating solution nozzles 43 formed in the entire lower surface of each lid member 13a. The discharge openings of the treating solution nozzles 43 are directed to the surface of the treating solution. As in the first to fourth embodiments, a mechanism is provided for adjusting the angle of the discharge openings of the treating solution nozzles 43.

When the treating solution nozzles 43 supply the treating solution to the surface of the treating solution, as indicated by arrows in FIG. 14, part of the bubbles Mb struck by the supply are destroyed. By this destructive action, the bubbles Mb are removed from the inner tank 11.

The functions and effects of the substrate treating method and substrate treating apparatus in the fourth embodiment are the same as in the third and fourth embodiments, the only difference being the flows of the treating solution and bubbles Mb.

This invention is not limited to the foregoing embodiments, but may be modified as follows:

(1) Each of the foregoing embodiments has been described, exemplifying stripping treatment for removing coating film formed on substrates. The invention is applicable to various other treatments such as etching and cleaning, as long as bubbles are formed as a result of a reaction between a treating solution and substrates.

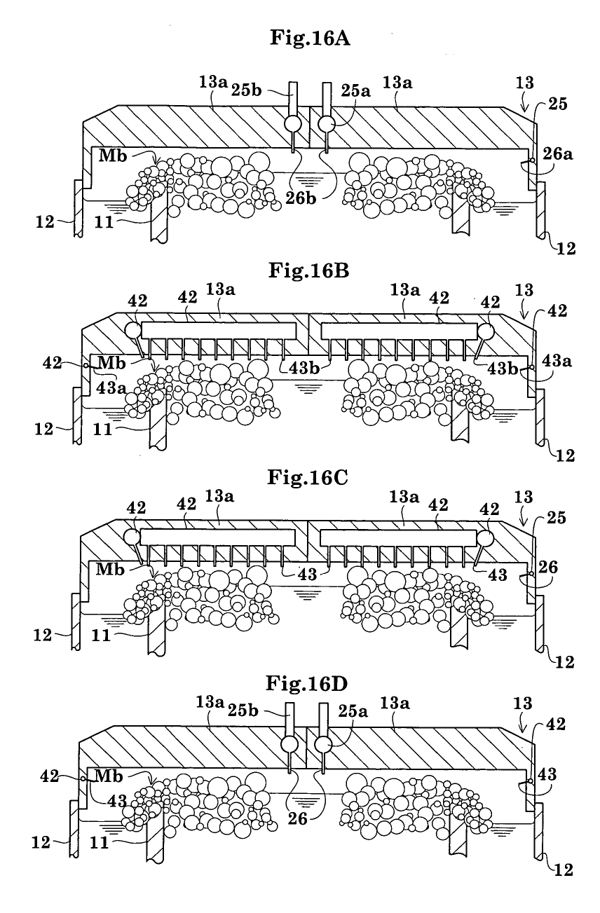

(2) The embodiments described above may be combined as appropriate. For example, the first embodiment and second embodiment may be combined as shown in a sectional view of FIG. 16A. In this combination, nitrogen gas nozzles 26a are arranged on the side wall of one lid member 13a adjacent the outer tank 12, and nitrogen gas nozzles 26b are arranged also adjacent the center of the lid members 13a. As shown in the sectional view of FIG. 16B, the third embodiment and fourth embodiment may be combined, with treating solution nozzles 43a arranged on the side wall of each lid member 13a adjacent the outer tank 12, and treating solution nozzles 43b arranged along three sides of the lid members 13a to surround the area above the outer tank 12.

As shown in the sectional view of FIG. 16C, the first embodiment and third embodiment may be combined, with the nitrogen gas nozzles 26 arranged on the side wall of one lid member 13a adjacent the outer tank 12, and treating solution nozzles 43 arranged along three sides of the lid members 13a to surround the area above the outer tank 12. As shown in the sectional view of FIG. 16D, the second embodiment and fourth embodiment may be combined, with treating solution nozzles 43 arranged on the side wall of each lid member 13a adjacent the outer tank 12 and nitrogen gas nozzles 26 arranged adjacent the center of the lid members 13a. The form of each supply system is not limited to what is shown in each embodiment, but may be varied according to the design of the treating tank 10 and the state of bubbles generated.

(3) The nitrogen gas used in the first and second embodiments may be heated to a higher temperature than the treating solution to be supplied to the surface of the treating solution. The treating solution is at about 70° C. in the first to fifth embodiments, and the nitrogen gas may be heated to about 100° C. Since the nitrogen gas supplied to the surface of the treating solution is hotter than the bubbles on the treating solution surface, the bubbles tend to disappear by supplying the hot nitrogen gas to the surface of the treating solution. Since nitrogen gas is an inert gas, bubbles may be eliminated while performing the treatment smoothly with no chemical reaction occurring with the treating solution.

(4) In the first and second embodiments, nitrogen gas is used to drive the bubbles outwardly of the treating tank (i.e. to the outer tank 12). The invention is not limited to a particular fluid for driving the bubbles outwardly of the treating tank. A gas, which flows along the surface of the treating solution, can easily drive the bubbles outwardly of the treating tank. In the case of a gas, use of an inert gas, typically nitrogen gas, is desirable as in the first and second embodiments in view of causing no chemical reaction with the treating solution. A rare gas, typically helium, neon or argon, which is an inert gas may also be used to drive bubbles outwardly of the treating tank. Nitrogen gas hotter than the treating solution is used in modification (3) above. However, nitrogen gas is not limitative, but a different gas hotter than the treating solution may be used only if it can eliminate the bubbles. In this case also, an inert gas hotter than the treating solution is desirable in view of causing no chemical reaction with the treating solution.

This invention may be embodied in other specific forms without departing from the spirit or essential attributes thereof and, accordingly, reference should be made to the appended claims, rather than to the foregoing specification, as indicating the scope of the invention.

What is claimed is:

1. A substrate treating method for treating substrates with a treating solution, comprising:
a step of supplying a fluid to a surface of the treating solution in a tank from one side of the tank, while the substrates are immersed in the treating solution, to drive bubbles present on the surface of the treating solution to a side opposed to said one side and outwardly of the tank.

2. A substrate treating method for treating substrates with a treating solution, comprising:
a step of supplying a fluid to a central region on a surface of the treating solution stored in a tank, while the substrates are immersed in the treating solution, to drive bubbles from the central region on the surface of the treating solution outwardly toward peripheries of the tank.

3. A substrate treating method as defined in claim 1, wherein said fluid is an inert gas.

4. A substrate treating method as defined in claim 2, wherein said fluid is an inert gas.

5. A substrate treating method for treating substrates with a treating solution, comprising:
a step of supplying a fluid to a surface of the treating solution stored in a tank, while the substrates are immersed in the treating solution, to destroy bubbles present on the surface of the treating solution with the fluid.

6. A substrate treating method as defined in claim 5, wherein said fluid is the same treating solution as the treating solution stored in the tank.

7. A substrate treating method as defined in claim 6, wherein the treating solution supplied to the surface of the treating solution comprises part of the treating solution once discharged from the tank.

8. A substrate treating method as defined in claim 5, wherein said fluid is an inert gas hotter than the treating solution.

9. A substrate treating apparatus for treating substrates with a treating solution, comprising:
a tank for storing the treating solution; and
a fluid supply mechanism for supplying a fluid to a surface of the treating solution in the tank from one side of the tank, while the substrates are immersed in the treating solution, to drive bubbles present on the surface of the treating solution to a side opposed to said one side and outwardly of the tank.

10. A substrate treating apparatus as defined in claim 9, further comprising an open/close lid having two lid members for opening and closing an upper opening of the tank, said fluid supply mechanism being disposed on one of the two lid members.

11. A substrate treating apparatus for treating substrates with a treating solution, comprising:
a tank for storing the treating solution; and
a fluid supply mechanism for supplying a fluid to a central region on a surface of the treating solution in the tank, while the substrates are immersed in the treating solution, to drive bubbles from the central region on the surface of the treating solution outwardly toward peripheries of the tank.

12. A substrate treating apparatus as defined in claim 11, further comprising an open/close lid having two lid members for opening and closing an upper opening of the tank, said fluid supply mechanism being disposed on each of the two lid members.

13. A substrate treating apparatus as defined in claim 9, wherein said fluid is an inert gas.

14. A substrate treating apparatus as defined in claim 11, wherein said fluid is an inert gas.

15. A substrate treating apparatus for treating substrates with a treating solution, comprising:
a tank for storing the treating solution; and
a fluid supply mechanism for supplying a fluid from at least two opposite directions to a surface of the treating solution stored in the tank, while the substrates are immersed in the treating solution, to destroy bubbles present on the surface of the treating solution with the fluid.

16. A substrate treating apparatus for treating substrates with a treating solution, comprising:
an inner tank for storing the treating solution;
an outer tank for collecting the treating solution overflowing an upper opening of the inner tank;
piping having one end thereof connected to the outer tank for discharging the treating solution from the outer tank; and
a fluid supply mechanism connected to the other end of the piping for supplying the treating solution discharged from the outer tank, from at least two opposite directions to a surface of the treating solution stored in the inner tank, while the substrates are immersed in the treating solution, to destroy bubbles present on the surface of the treating solution with the treating solution supplied.

17. A substrate treating apparatus as defined in claim 15, further comprising an open/close lid having two lid members for opening and closing an upper opening of the tank, said fluid supply mechanism being disposed on each of the two lid members.

18. A substrate treating apparatus as defined in claim 16, further comprising an open/close lid having two lid members for opening and closing upper openings of the inner and outer tanks, said fluid supply mechanism being disposed on each of the two lid members.

19. A substrate treating apparatus as defined in claim 9, wherein said fluid supply mechanism has an adjustable fluid delivery angle.

20. A substrate treating apparatus as defined in claim 11, wherein said fluid supply mechanism has an adjustable fluid delivery angle.

21. A substrate treating apparatus as defined in claim 15, wherein said fluid supply mechanism has an adjustable fluid delivery angle.

22. A substrate treating apparatus as defined in claim 16, wherein said fluid supply mechanism has an adjustable fluid delivery angle.

23. A substrate treating apparatus for treating substrates with a treating solution, comprising:
an inner tank for storing the treating solution;
an open/close lid having two lid members for opening and closing an upper opening of the tank; and
a fluid supply mechanism for supplying the treating solution to a surface of the treating solution stored in the inner tank, while the substrates are immersed in the treating solution, to destroy bubbles present on the surface of the treating solution with the treating solution supplied, said fluid supply mechanism including plate-like nozzles formed on said two lid members, respectively, and each having a plurality of discharge openings.

24. A substrate treating apparatus as defined in claim 23, further comprising:
an outer tank for collecting the treating solution overflowing the upper opening of the inner tank; and
piping having one end thereof connected to the outer tank for discharging the treating solution from the outer tank;
said plate-like nozzles being connected to the other end of the piping for supplying the treating solution from said discharge openings to an entire surface of the treating solution stored in the inner tank.
